(19) United States
(12) Patent Application Publication
(10) Pub. No.: US 2008/0142768 A1
(43) Pub. Date: Jun. 19, 2008

(54) Leveling system for recreational vehicles

(76) Inventors: Jim Thorpe, Paso Robles, CA (US); Craig A. von Ilten, Arroyo Grande, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/638,607

(22) Filed: Dec. 13, 2006

(51) Int. Cl. B60S 9/14; G06F 7/00

(52) U.S. Cl. 254/423; 701/36

(57) ABSTRACT

A leveling system for use with recreational vehicles having one or more leveling mechanisms to level the vehicle in the side-to-side and front-to-back directions. The invention comprises a level unit that is placed on a generally horizontal surface inside the vehicle and a control unit which is in spaced apart relation to the level unit. Both units have a controller and transceiver for wireless communication with the other unit and one or more batteries as the power supply. The level unit has one or more level sensing mechanisms to determine the pitch and roll of the vehicle. Preferably, a single dual-axis tilt measuring mechanism is utilized. The control unit has one or more control buttons to allow the operator to activate and operate the system and a display panel that displays the amount of pitch and roll correction necessary to place the recreational vehicle in its level condition.

### CROSS-REFERENCE TO RELATED APPLICATIONS

None.

### BACKGROUND OF THE INVENTION

A. Field of the Invention

The field of the present invention relates generally to apparatuses and systems for leveling recreational vehicles, trailers and the like. More specifically, this invention relates to leveling systems that are utilized in conjunction with the vehicle's jack or other leveling mechanisms to level the vehicle when it is stationary. Even more specifically, this invention relates to such leveling systems that can be wirelessly operated and are adapted for use with all types of recreational vehicles and leveling mechanisms.

B. Background

Many people utilize recreational vehicles for camping, attending sporting events, attending product shows and conventions or traveling from one place to another. For purposes of this disclosure, recreational vehicles include those that are motorized, meaning they have a gasoline, diesel or other type of motor that drives the vehicle from one location to another, and those that are configured as a trailer, such as the fifth wheel trailer shown in FIG. 1, that must be towed behind a car or truck. When a recreational vehicle is to be parked for any extended period of time, a set of jacks, leveling blocks or other vehicle leveling mechanisms are utilized to level and support the recreational vehicle. This is particularly true for non-motorized recreational vehicles, where the removal of the towing vehicle necessitates additional support to place and maintain the floor of the recreational vehicle in a substantially horizontal position. One of the most common types of leveling mechanisms utilized by recreational vehicles, which are typically installed by the manufacturer, are scissor and telescoping jacks. Although retrofitting is an available option, this generally requires alterations to the vehicle, which can be difficult and expensive to accomplish. The leveling block type of leveling mechanism can be generally rectangular or ramp-shaped blocks, which are usually provided with a non-slip upper surface, that are configured to allow the user to drive the vehicle's wheel(s) up on one or more blocks. Typically, the leveling mechanisms are utilized at or near the sides and/or front and rear of the recreational vehicle and are adjusted to level the vehicle by raising, as opposed to lowering, one or more of the sides or ends of the vehicle an appropriate amount. The jacks or other leveling mechanisms attach, often permanently, to the frame of the recreational vehicle to support the vehicle above the ground or other surface on which the it is parked.

Once the recreational vehicle is driven to the location where it will be parked, such as a campground or sporting event, the leveling mechanisms are engaged to take much of the weight off of the vehicle's wheels and to support the vehicle in a generally horizontal, level position. While the vehicle is parked, with its leveling mechanism engaged, people will move around inside the recreational vehicle. Naturally, for comfort purposes, the people in the recreational vehicle prefer the vehicle to be substantially level. In addition, proper opening and closing of cabinet doors and kitchen appliances also require the recreational vehicle be generally level in both directions (i.e., both left to right and front to back). Failure to properly level the recreational vehicle can result in doors that will not properly open or close, tables and other furniture that may not open properly and loose items rolling across the floor, table, counters or other surfaces inside the recreational vehicle.

Although many campsites or other recreational vehicle sites attempt to provide level parking places, very often the surface on which a recreational vehicle parks is not sufficiently level so as to eliminate the need for the operator to level the recreational vehicle before it can be comfortably and safely utilized. As a result, generally the operator must first level the recreational vehicle before he or she can use it for its intended purpose. This requires the operator to initially determine how far off of level the vehicle is and how much the low side of the vehicle must be raised to place it in a substantially level condition. Although not entirely accurate, many people utilize visual observation to determine how much to raise one side or end and then place a marble or ball-like object on a flat surface to see if the vehicle is sufficiently level. Some people use a sight-glass, hand level or other device to check the levelness of the vehicle. Unfortunately, in part due to the inherent inaccuracies of such systems, the operator generally has to readjust the leveling mechanism several times, with each time requiring him or her to go in and out of the vehicle to check whether the vehicle is sufficiently level. Depending on luck, the amount the ground is out of level and the person's experience, the process of leveling the vehicle can be somewhat frustrating. Generally this is not a good start to a vacation or other activity after, very often, driving many hours to get to the location.

A number of patents describe leveling mechanisms that are useful for leveling a recreational vehicle. For instance, U.S. Pat. No. 6,439,543 to Peckham discloses a leveling device comprised of a plurality of supports that stack on each other to define a ramp having a desired height for receiving one of the vehicle's wheels thereon. Each of the supports have an angled front wall and interlocking top and bottom walls that facilitate the desired stacking arrangement. U.S. Pat. No. 6,644,628 to Triche discloses a vehicle leveling apparatus that comprises a leveling track that defines a channel in which is received the two adjacent wheels on one side of the vehicle. The leveling track is pivotally supported by a support base to level the vehicle. U.S. Pat. No. 6,425,604 to Schubert, et al. discloses a vehicle leveling assembly having a leg which is extendable to the ground and in operable communication with a cogwheel gear mechanism to extend the leg to the desired height. U.S. Pat. No. 5,273,297 to Gerdes discloses a leveling system for vehicles that utilizes hydraulic work cylinders disposed between the vehicle body and wheel support that are controlled by a single pressure regulating valve. The work cylinders have a hydraulically controlled main valve and an electromagnetically controlled pilot valve. U.S. Pat. No. 6,082,743 to Black discloses a method of leveling a recreational vehicle that comprises the steps of driving at least one tire on top of an inflatable container, partially inflating the container, conforming the container to the tire by partially wrapping it around the tire, establishing the vehicle in a leveled position and then supporting the vehicle in the leveled position. The foregoing patents are representative of leveling systems that require manual, independent determination of the amount of height adjustment needed to place the vehicle in the level condition. As set forth above, determining whether the vehicle is level or not requires the operator to utilize visual determination (i.e., eye-balling) or the use of a sight-level.

Other patents disclose recreational vehicle leveling systems that are built into or substantially incorporated with the recreational vehicle. As stated above, these systems are generally provided from the manufacturer with the vehicle and are somewhat costly to retrofit onto an existing vehicle. An example of such an integrated system is U.S. Pat. No. 5,176,391 to Schneider, et al., which discloses a vehicle leveling system having three extendable and retractable fluid-operated jacks, a supply of pressurized hydraulic fluid and a level-sensing switch that are mounted to the vehicle frame and operated by the vehicle's engine. The level-sensing switch is wired into a microprocessor control box that also connects to the jacks so as to control the leveling of the vehicle. The processor checks the pressure inputs into the level-sensing switch to determine if one or more of the jacks is lower than the others. This process is repeated until the inputs from the level-sensing switch indicate a level condition. U.S. Pat. No. 6,584,385 to Ford, et al. discloses a vehicle leveling assembly comprising a controller connected to one or more jack leveling devices and a two-axis tilt sensor that is connected to the controller and supported on the vehicle. The system utilizes an optimized leveling algorithm to automatically determine the amount and sequence to raise or lower one or more of the jacks to obtain the vehicle level condition.

While the forgoing patents describe leveling apparatuses and systems that generally provide the operator with the ability to level a recreational vehicle, there is a need for a simpler, less expensive yet effective leveling system that is configured to indicate to the operate the amount a side or an end of the vehicle must be raised to place the vehicle in a level condition. The preferred leveling system should communicate to the operator the amount the front or rear of the vehicle must be raised and the amount the left or right side must be raised to place the vehicle in the level condition. The preferred leveling system should be suitable for use with variety of recreational vehicles without requiring modifications or alterations to the vehicles, such that it can be economically utilized with existing vehicles as well as new vehicles. The preferred leveling system should also be suitable for use with a wide variety of different leveling mechanisms that are presently utilized to level recreational vehicles. It is also preferred that the leveling system include a visual indicating means to inform the operator of the amount a side or an end must be raised to place the vehicle in a substantially level condition. The preferred leveling system also includes a procedure for allowing the operator to calibrate the system for the zero or level condition.

### SUMMARY OF THE INVENTION

The leveling system for recreational vehicles of the present invention provides the benefits and solves the problems identified above. That is to say, the present invention discloses a leveling system that communicates to the operator the amount one of the sides and/or one of the ends of the vehicle must be raised to place the vehicle in a level condition. In the preferred embodiment of the present invention, the leveling system has a level unit which determines how level the vehicle is and wirelessly transmits that information to a control unit which visually indicates to the operator the amount the recreational vehicle is out of level in degrees and the amount needed to raise a side or end of the vehicle in order to level the vehicle. The leveling system of the present invention provides an easy to use, easy to install and less expensive, yet effective, system to determine the amount of adjustment necessary to level a wide variety of recreational vehicles without requiring modifications or alterations to the vehicle itself. The leveling system of the present invention is suitable for use with virtually all types of leveling mechanisms, including those that utilize jack mechanisms, such as scissor or telescoping jacks, or block members to raise one side or end of the vehicle to place it in the level condition. As such, the leveling system of the present invention can be economically utilized with both existing and new recreational vehicles and leveling mechanisms. The leveling system of the present invention includes a calibration procedure to allow the operator to selectively calibrate the zero or level condition.

In one general aspect of the present invention, the leveling system is utilized with a recreational vehicle having a leveling mechanism, such as jacks or blocks, associated therewith and comprises a level unit that is configured to wirelessly communicate leveling information to a control unit. The level unit has having a level housing that encloses a controller, a level sensing means, a power supply and a transceiver mounted on a circuit board. The level sensing means is configured to determine the pitch and the roll of the recreational vehicle so the user can operate the leveling mechanism to place the recreational vehicle in its level condition. Although separate tilt sensors can be utilized, in the preferred embodiment the level sensing means is a dual-axis accelerometer that is configured to determine the tilt of the recreational vehicle in both the front-to-back and side-to-side directions. In the preferred embodiment, the controller and the transceiver is a single integrated unit tat wireless transmits the data from the level sensing means to the control unit. Also in the preferred embodiment, the power supply is one or more batteries. The control unit, which is in spaced apart relation to and communication with the level unit, has a control housing that encloses a circuit board having a controller, transceiver and a power supply. In the preferred embodiment, the same circuit board, having the same controller and transceiver as the level unit is utilized for the control unit to reduce manufacturing costs. The control unit also has a display panel for displaying the pitch and roll information received from the level unit and one or more operator accessible control buttons for activating and operating the leveling system. Unlike other systems, the level unit and the control unit are separate from the leveling mechanism and not tied to a specific recreational vehicle, thereby allowing use of the system with a wide variety of leveling mechanisms configured to level a variety of recreational vehicles. The operator of the recreational vehicle utilizes the pitch and roll information, transmitted from the level unit and displayed on the control unit's display panel, to operate the leveling mechanism so as to place the recreational vehicle in its level condition.

Accordingly, the primary objective of the present invention is to provide a leveling system for recreational vehicles that provides the advantages discussed above and overcomes the disadvantages and limitations which are associated with presently available systems and method of determining the amount needed to raise a side or an end of the trailer in order to place in a substantially level condition.

An important objective of the present invention is to provide a leveling system for recreational vehicles that is easy to use, easy to install, relatively inexpensive to manufacture and effective at determining the amount needed to raise a side and/or an end of the recreational vehicle to place it in a level condition.

It is also an important objective of the present invention to provide a leveling system for recreational vehicles that is utilized with the vehicle's leveling mechanism to level the vehicle.

It is also an important objective of the present invention to provide a leveling system for recreational vehicles that wirelessly transmits leveling information from a mounted level unit to a control unit, which can be held in the operator's hand or attached to a visor or other component of the recreational vehicle.

Another important objective of the present invention is to provide a leveling system for recreational vehicles that is adaptable for use with a wide variety of recreations vehicles and leveling mechanisms, including scissor and telescoping jack systems and block systems, to level the vehicle without requiring modifications or alterations to the vehicle or leveling mechanism.

Yet another important objective of the present invention is to provide a leveling system for recreational vehicles that communicates to the operator, such as by a visual indicating means, the amount necessary to raise a side and/or an end of the recreational vehicle to place it in a level condition.

Yet another important objective of the present invention is to provide a leveling system for recreational vehicles that provides the operator with the ability to set the calibration for a zero or level condition from which future measurements will be taken to determine the amount a side and/or an end of the vehicle must be raised to place it in the preset level condition.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side perspective view of a prior art configuration of a recreational vehicle having scissor and telescoping leveling jacks as the leveling mechanisms which can be utilized with the leveling system of the present invention;

FIG. 2 is a side perspective view of the level and control units of the leveling system of the present invention attached;

FIG. 3 is a top view of the level unit utilized with a preferred embodiment of the leveling system of the present invention shown in FIG. 2;

FIG. 4 is a bottom view of the level unit of FIG. 3;

FIG. 5 is a top view of the level unit of FIG. 3 with the top cover removed to show the interior chamber thereof and components disposed therein;

FIG. 6 is a front view of the control unit utilized with a preferred embodiment of the leveling system of the present invention shown in FIG. 2;

FIG. 7 is a back view of the control unit of FIG. 7;

FIG. 8 is a front perspective view of the control unit of FIG. 7 with the front cover removed to show the interior chamber thereof and the components disposed therein;

FIG. 9 is a schematic diagram of the portion of the circuit board utilized with a preferred embodiment of the level and control units of the leveling system of the present invention showing the on-board microcontroller having integrated wireless WIFI circuitry;

FIG. 10 is a schematic diagram of the portion of the circuit board utilized with a preferred embodiment of the level and control units of the leveling system of the present invention showing the power circuits;

FIG. 11 is a schematic diagram of the portion of the circuit board utilized with a preferred embodiment of the level and control units of the leveling system of the present invention showing the circuitry utilized with the level unit to determine the levelness of the recreational vehicle; and

FIG. 12 is a schematic diagram of the portion of the circuit board utilized with a preferred embodiment of the level and control units of the leveling system of the present invention showing the LCD screen of the control unit utilized to transmit the leveling information to the operator.

### DETAILED DESCRIPTION OF THE PREFERRED EMBODIMENTS

With reference to the figures where like elements have been given like numerical designations to facilitate the reader's understanding of the present invention, and particularly with reference to the embodiments of the leveling system for recreational vehicles of the present invention illustrated in the figures, various preferred embodiments of the present invention are set forth below. The enclosed description and drawings are merely illustrative of one or more preferred embodiments and represent at least one of several different ways of configuring the present invention. Although specific components, materials, configurations and uses of the present invention are illustrated and set forth in this disclosure, it is understood that a number of variations to the components and to the configuration of those components described herein and in the accompanying figures can be made without changing the scope and function of the invention set forth herein.

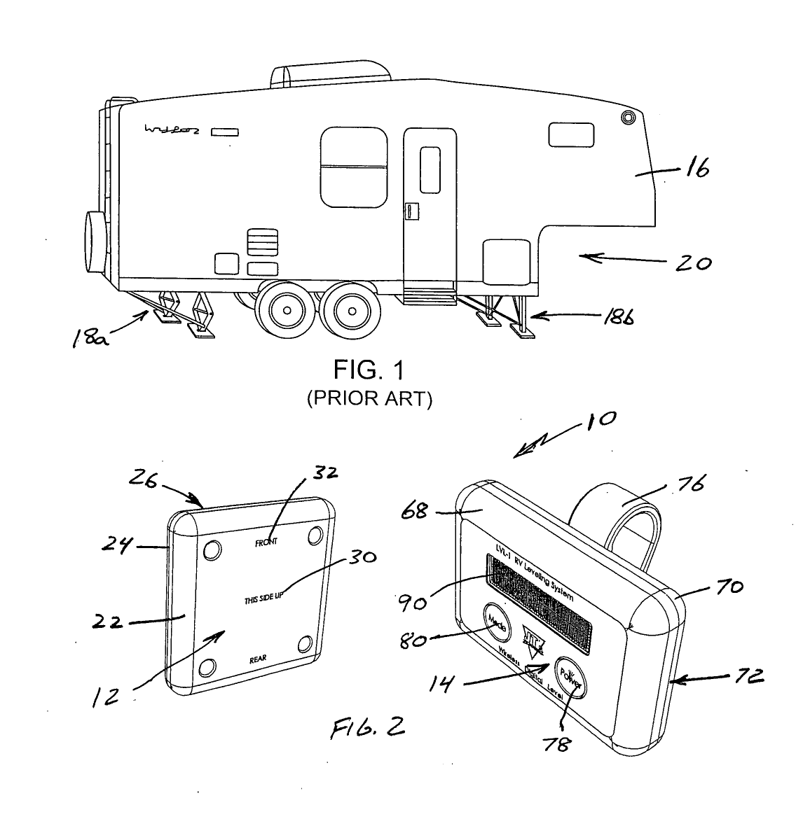

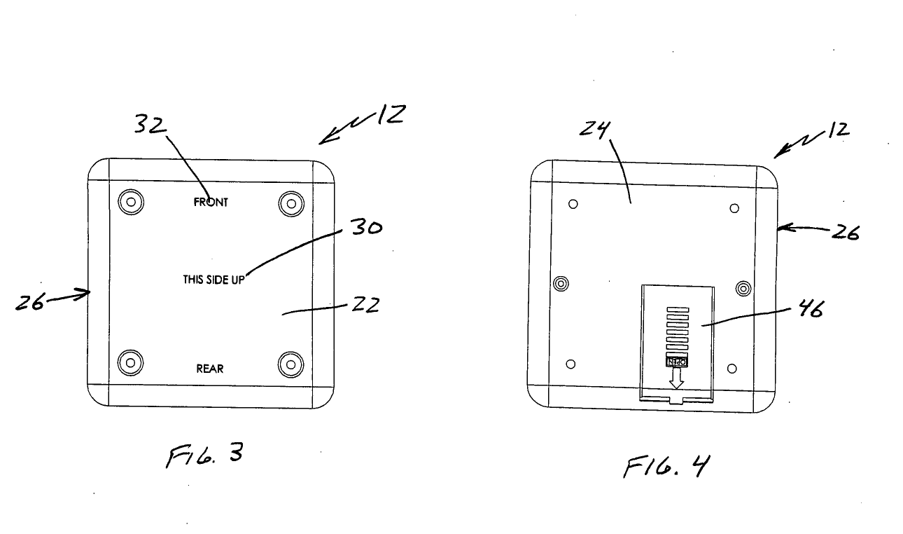

A leveling system for recreational vehicles manufactured out of the materials and pursuant to the system of the present invention, shown as 10 in FIG. 2, generally comprises a level unit 12 and a separate control unit 14 that is in spaced apart relation to level unit 12. The leveling system 10 of the present invention is configured to assist an operator with leveling a recreational vehicle 16 having one or more leveling mechanisms 18 associated therewith, such as a scissor jack 18a and/or a telescoping jack 18b, as shown in FIG. 1. The leveling mechanisms 18 are shown extended in their leveling/stabilizing position, to level and support the floor of recreational vehicle 16 in a generally horizontal, level condition 20. Leveling system 10 of the present invention can be utilized with a variety of different types of recreational vehicles 16 and leveling mechanisms 18 in addition to the fifth wheel vehicle 16 and leveling mechanisms 18a and 18b shown in FIG. 1. For instance, leveling system 10 can be utilized with the trailer-type of recreational vehicle or those recreational vehicles that are motorized instead of the tow-behind type. Leveling mechanisms 18 utilized with leveling system 10 can include those having one or more mechanically, hydraulically, pneumatically or electrically actuated jacks. In addition, leveling mechanism 18 can be of the block type, as set forth in the prior art discussed above, or any of a wide variety of leveling mechanisms having different configurations and operations. As well known to those skilled in the art, leveling mechanisms 18 are generally utilized to place the recreational vehicle 16 in a relatively level condition for the comfort of those inside and for smooth operation of the vehicle's doors and appliances. As will be readily understood by those skilled in the art and those who operate recreational vehicles, such as the fifth wheel trailer vehicle 16 shown in FIG. 1, leveling system 10 of the present invention is configured to be independent of the specific recreational vehicle 16 and leveling mechanism 18 used to level recreational vehicle 16.

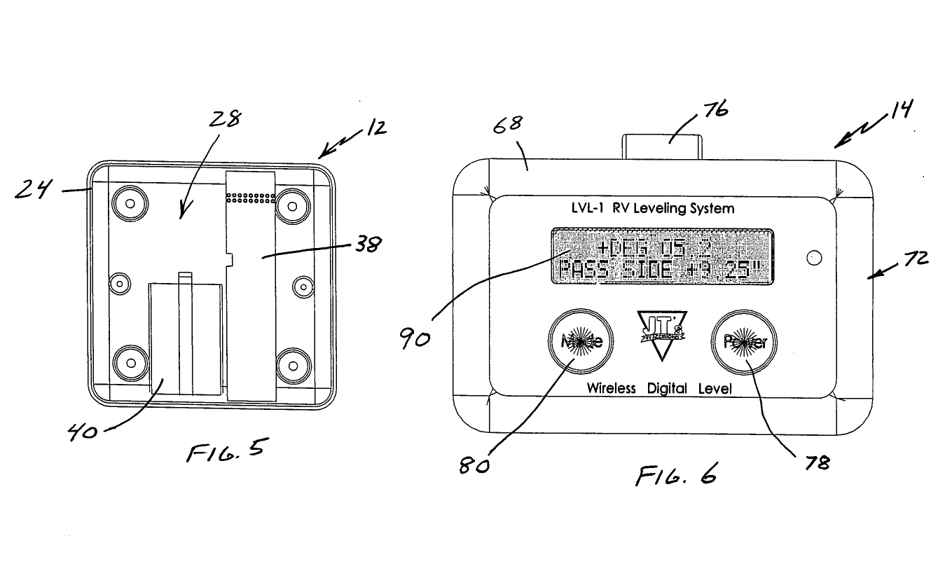

As best shown in FIGS. 3 through 5, level unit 12 has a top cover 22 and a bottom cover 24 that define a level housing 26 enclosing level chamber 28 in which is disposed the components that determine how level the recreational vehicle 16 is relative to its desired level condition 20. In a preferred embodiment, level unit 12 does not have any user accessible buttons or other controls or any display panels that are or need to be accessible to or viewed by the operator for use of level unit 12. Instead, the operator changes the operating conditions of level unit 12, if necessary, through use of control unit 14. In an alternative configuration, not shown, user accessible buttons and/or a display panel can be used with level unit 12 to allow the operator to directly access the operation of level unit 12. The top cover 22 of level unit 12 has one or more top side indicating means 30, such as the “THIS SIDE UP” indicator shown in FIG. 3, to indicate to the operator which side he or she should place facing upward when level unit 12 is installed inside recreational vehicle 16. The top cover 22 of level unit 12 also has one or more position indicating means 32, such as the “FRONT” and “REAR” indicators shown in FIG. 3, that indicate to the operator which sides of the level unit 12 should be placed toward the direction of the front and rear of the vehicle, also indicating by default the left and right side directed positions. As will be readily apparent to those skilled in the art, various other mechanisms can be utilized to indicate the top side of level housing 26 and the proper positioning of level unit 12, including but not limited to arrows, colors, lights (i.e., a LED), markers and the like. Proper placement of level unit 12 is necessary for the operation of level unit 12 to determine the amount of pitch (front/back angle) and roll (left/right) for analyzing the attitude of recreational vehicle 16 relative to a calibrated reference position or predetermined attitude at level condition 20. As set forth in more detail below, level unit 12 is placed on a flat surface inside recreational vehicle 16, such as on a cabinet shelf or on top of a counter or the like, to allow the components disposed in interior chamber 28 of level unit 12 to measure the pitch and roll tilt so that leveling system 10 can determine the adjustment necessary to neutralize that tilting.

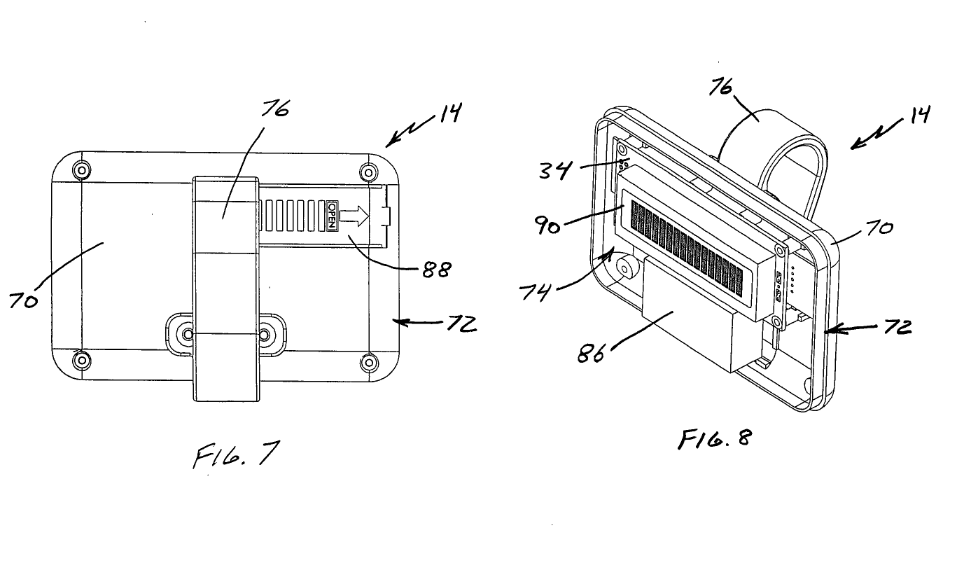

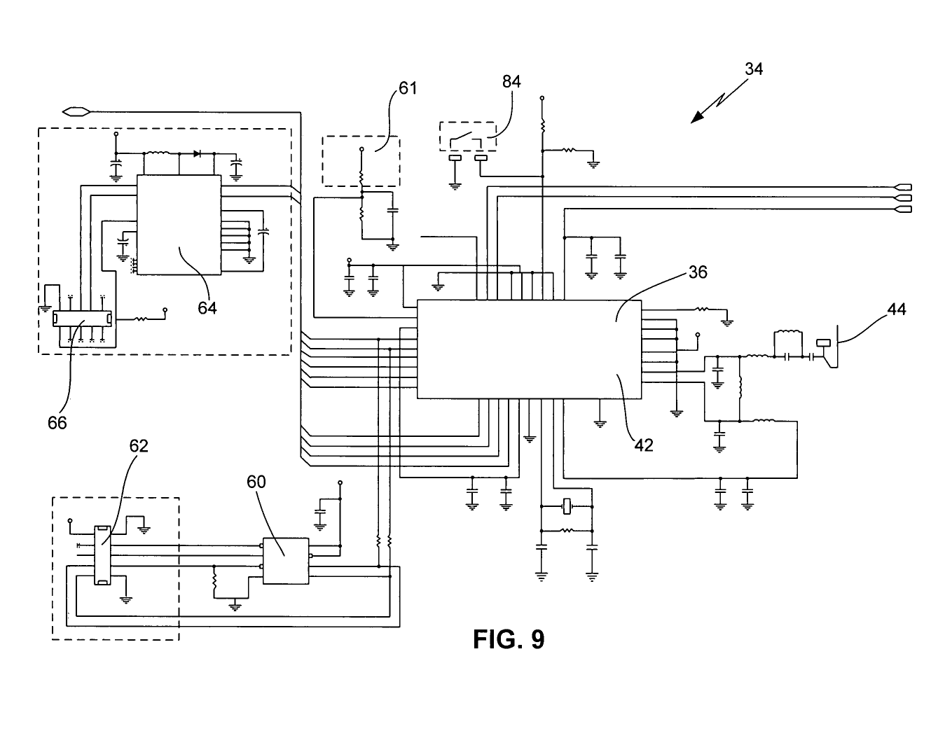

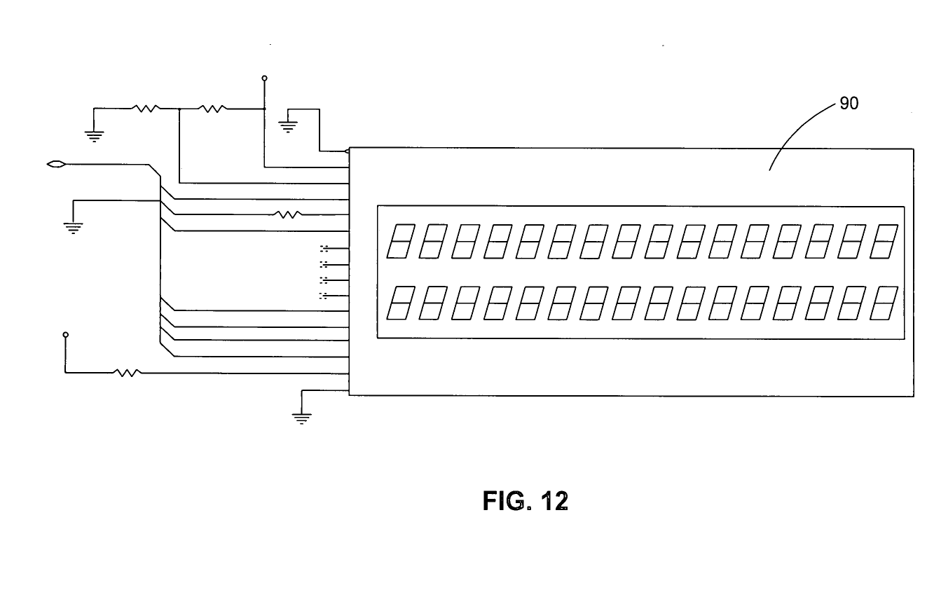

As stated above, disposed inside interior chamber 28 of level housing 26 are the components that provide the level determination functions of level unit 12. These components include a circuit board 34, shown in FIGS. 9 through 12, having a controller 36 which is operatively connected to a level sensing means 38, power supply 40 and transmitter/receiver or transceiver 42, including antenna 44. In a preferred embodiment, shown in the figures, the controller 36 includes transceiver 42. As an example of a device that can be utilized with the present invention, controller 36 can be a Nordic Semiconductor model number nRF24E1 2.4 Ghz RF transceiver that is integrated with an 8051 compatible microcontroller. The on-board wireless circuitry for transceiver 42 on controller 36 provides an integrated WiFi capability that allows level unit 12 to wirelessly communicate with control unit 14, which as described below also includes transceiver 42. As shown on FIG. 5, power supply 40 can be one or more batteries, such as four AA 1.5 volt batteries, that are removable through battery compartment door 46 on the bottom cover 24 of level housing 26 (shown on FIG. 46).

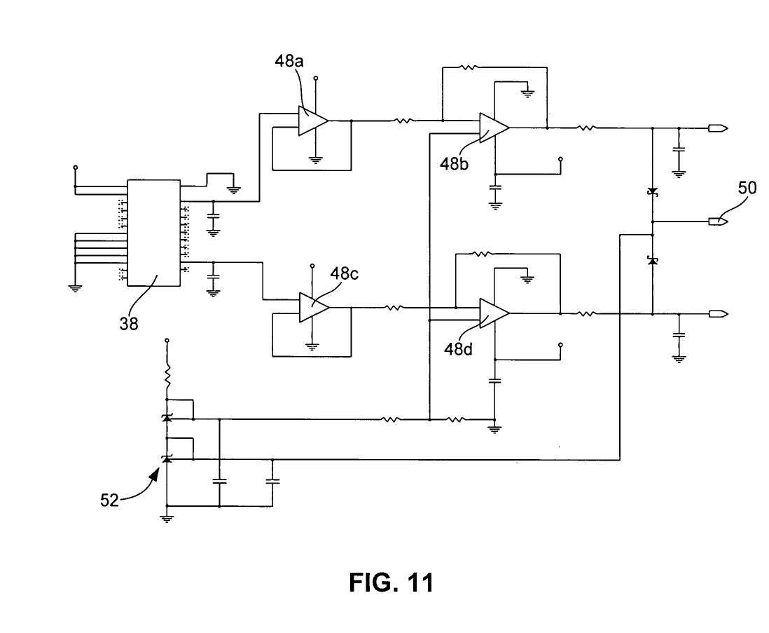

Level sensing means 38 comprises one or more tilt sensors that are configured to detect the amount of pitch and roll of recreational vehicle 16. In one configuration, level sensing means 38 comprises two separate tilt sensors, one positioned in the front/back direction for determining the pitch and one positioned in the left/right direction for determining the roll. In a preferred embodiment of the present invention, however, level sensing means 38 is a dual-axis accelerometer, such as the model number LIS2L02AS4 low-power two-axis linear accelerometer available from ST Microelectronics, that is configured to detect tilting in both the front/back and left/right directions so as to determine the attitude of recreational vehicle 16 relative to a calibrated reference position (i.e., the level condition 20). The level sensing means 38 includes an integrated circuit interface that takes the information from the sensing element of sensing means 28 to deliver an analog signal for conversion and then use by control unit 14. As shown in FIG. 11, the output from level sensing means 38 goes to one or more analog conversion devices, such as the operation amplifiers 48a, 48b, 48c and 48d, that convert the analog signal to a linear value that is used by controller 36 to determine the pitch and roll level position relative to the common reference 50. This data is then wirelessly transmitted to control unit 14 for processing into operator-useable information. Alternatively, controller 36 or level unit 12 can process the data and transmit the final tilt adjustment data to control unit 14 for display to the operator. A bandwidth limiter 52 is utilized to prevent damage to controller 36 from over-voltage conditions, such as may result due to vibrations that can result from recreational vehicle 16 driving down the road or, in some circumstances, from movement inside recreational vehicle 16.

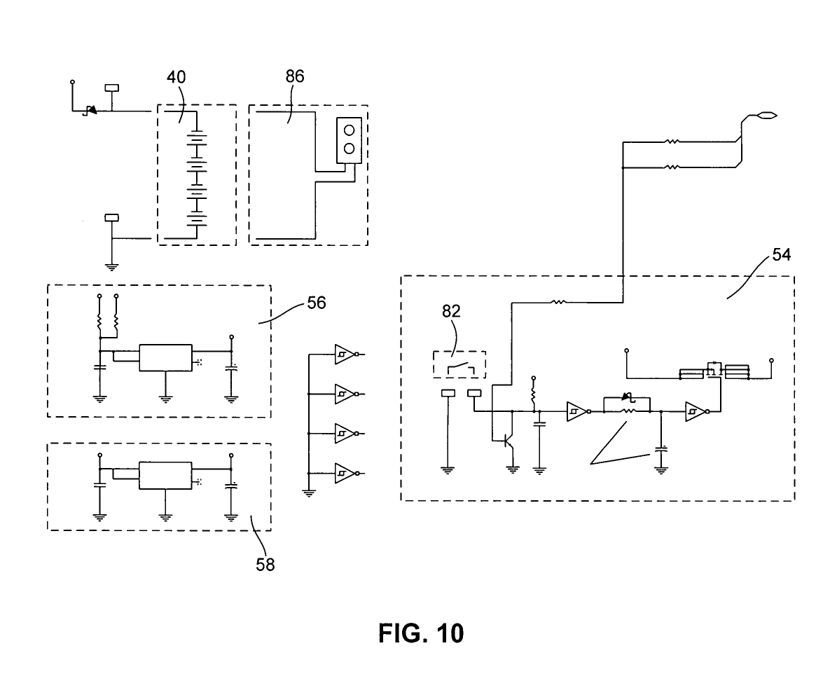

In a preferred embodiment, the same circuit board 34 is utilized for both level unit 12 and control unit 14 to reduce manufacturing costs. Although many of the components are loaded on and, therefore, common to both circuit boards 34, some of the components are selectively chosen depending on whether the circuit board 34 is for level unit 12 or control unit 14. For instance, controller 36 and transceiver 42, preferably in an integrated chip, are utilized on both units. Both level 12 and control 14 units also have a re-triggerable power control circuit 54, shown in FIG. 10, that continues to re-trigger the units such that they turn off after a set amount of time of inactivity but they will stay on if the unit is performing a task for the operator. FIG. 10 also shows the use of one or more step down circuits, such as the low drop out 3.3 volt step down circuit 56 and the low drop out 5 volt step down circuit 58. As shown on FIG. 9, the circuit boards 34 of level 12 and control 14 units also include a flash memory chip 60 to store data useful for the operation of leveling system 10 and a battery monitoring circuit 61 to monitor the electrical power remaining in the batteries 40 and 86 used for level unit 12 and control unit 14, respectively. The circuit board 34 shown in the figures also includes a memory chip connector 62 for programming the flash memory chip 60 with the manufacturer's computer control code and a diagnostic chip 64, with an appropriate serial connector 66, for debugging controller 36 that may be useful for development of leveling system 10. Neither the memory chip connector 62, diagnostic chip 64 nor serial connector 66 may need to be included on actual production models of system 10.

As best shown in FIGS. 2 and 6 through 8, control unit 14 has a front cover 68 and back cover 70 that define control housing 72 enclosing a control chamber 74 in which is disposed the components that allow the user to control leveling system 10 and communicate with the spaced apart level unit 12. The components inside control chamber 74 include the circuit board 34 having controller 36 and transceiver 42, which as discussed above are preferably provided as a single, integrated component. In a preferred embodiment, a clip member 76 is attached to the back cover 70 of control unit 14 to allow the user to attach control unit 14 to a visor or the like in the vehicle used to tow recreational vehicle 16 or, depending on the type of recreational vehicle 16, in the driving compartment thereof. If desired, one or more alternative or additional attachment mechanisms may be utilized, such as a magnet, double side tape, adhesive or the like, instead of clip member 76 to attach control unit 14 to a location that is convenient for the operator. Preferably, any such attachment mechanism is removable from the location where it is stored to allow the operator to utilize control unit 14 as a hand-held device so that he or she may stand outside recreational vehicle 16 during use of leveling system 10 to level recreational vehicle 16. The front cover 68 of control unit 14 also includes one or more operator accessible control buttons, such as power button 78 and mode button 80. Power button 78, which connects to circuit board 34 at on/off switch 82 on FIG. 10, is used to turn on or off control unit 14. Mode button 80, which connects to circuit board 34 at mode switch 84 on FIG. 9, is used to switch control unit 14 between its various display and function modes, such as showing the pitch or roll adjustments needed to obtain level condition 20. Control unit 14 also includes a power supply 86, such as the nine volt battery shown on FIGS. 8 and 10. Battery 86 can be added or replaced as necessary by use of battery compartment door 88 on the back cover 70 of control housing 72. To communicate information to the operator, control unit 14 includes a display panel 90 that is operatively connected to controller 36. In a preferred embodiment, display panel 90 is a LCD screen such as model number CFAH1602CYYHJPV available from Crystal Fontz. As shown in FIG. 6, display panel 90 can display the amount of pitch or roll in degrees and the amount in inches or other measurement units, based on a known length or width of recreational vehicle 16, that one end or side of the recreational vehicle 16 must be raised to place recreational vehicle 16 in level condition 20. Based on the information that is displayed by control unit 14, the operator utilizes one or more of the available leveling mechanisms 18 to raise the end or side of recreational vehicle 16.

Level housing 26 and control housing 72 can be made out of a variety of different materials and utilize different attachment mechanisms to attach to recreational vehicle 16 or the tow vehicle. In a preferred embodiment, housings 26 and 72 are made out of a molded plastic material having sufficient strength to avoid being easily damaged during normal use. Alternatively, these housings 26 and 72 can be made out of a wide variety of plastic, metal and/or composite materials or combinations thereof. Level unit 12 can include a connecting means to attach level housing 26 to a flat, generally horizontal surface inside recreational vehicle 16. In one embodiment, the connecting means comprises one or more through apertures 92 that are configured for the operator to insert a screw therethrough and into the flat mounting surface. Alternatively, double sided tape, magnets, adhesive, one or more engaging devices or a wide variety of other connecting mechanisms can be utilized to secure level unit 12 to the location from which the levelness of recreational vehicle 16 will be determined. As stated above, in the preferred embodiment a clip member 76 can be attached to the back cover 70 of control housing 72 for use in securing control unit 14 to a visor or like surface inside the tow vehicle or recreational vehicle 16. As known to those skilled in the art, various alternative attachment mechanisms can be utilized to removably attach control unit 14 to the tow vehicle or recreational vehicle 16. Although it is preferred to provide the operator with the ability to use control unit 14 in a remote, hand-held manner, control unit 14 can be fixedly attached to the tow vehicle or recreational vehicle 16.

Several alternative configurations can be utilized for leveling system 10 of the present invention. For instance, as stated above, level unit 12 and control unit 14 can have separately configured circuit boards instead of utilizing the same circuit board 34 with different components loaded thereon. If desired, a separate controller 36 and transceiver 42 components can be utilized instead of the preferred integrated controller 36 and transceiver 42 chip described above. Leveling system 10 can be configured to be fixedly installed, generally inside, on a recreational vehicle 16 by the manufacturer (i.e., built-in units) instead of the preferred mobile control unit 14 and operator selected positioning of the level unit 12. Likewise, level 12 and control 14 units can be interconnected with a wired system instead of the wireless communication of the preferred embodiment and/or one or both of the two units can be electrically wired into the electrical system of the recreational unit 16 or other sources of electrical power, including external battery systems utilizing a separate rechargeable system.

In use, the operator installs leveling system 10 by placing the level unit 12 on a flat, generally horizontal surface inside recreational vehicle 16 that is preferably located near the center of the recreational vehicle 16 around its axle area. Generally, it will be preferred to place level unit 12 on a cabinet shelf, cabinet top or counter top that is somewhat out of the way so as to not interfere with the operator's use and enjoyment of recreational vehicle 16. Level unit 12 should be secured in place so as to not move during movement of recreational vehicle 16. Once level unit 12 is set, it will generally not be necessary for the operator to access level unit 12 except to replace batteries 86. To set leveling system 10 for future use, it is preferred to place the recreational vehicle 16 in its level condition 20 based on the operator's preference and the smooth functioning of the cabinet and appliance doors and the levelness of the table, counter, floor and other surfaces. Once the recreational vehicle is set, the operator utilizes the control unit 14 to set the base or calibrated reference position at level condition 20. In a preferred configuration, this is accomplished by pushing and holding the mode button 80 for a predetermined amount of time, such as twenty seconds. This activity will set the reference position, from which the amount of out-of-level will be determined, to zero. This calibration step should be done even if the initial placement of level unit 12 indicates recreational vehicle 16 is level to ensure the surface on which level unit 12 is placed is not compensating for an incorrect level of recreational vehicle 16, thereby showing that recreational vehicle 16 is level when in reality it is not level (which can cause the door and appliance problems discussed above). Once leveling system 10 is calibrated, this step should not have to be performed again unless level unit 12 is moved. The control unit 14 can then be placed on a visor or like object inside the tow vehicle or the driving compartment of the recreational vehicle.

To level a recreational vehicle 16 having leveling system 10 after parking recreational vehicle 16 where desired, the operator will typically level the side-to-side position first, usually while still hooked up to the truck or other tow vehicle with control unit 14 on the tow vehicle's visor. The operator first activates the control unit 14 by pushing the power button 78 to turn leveling system 10 to its on condition. In the preferred embodiment, it is not necessary to manually activate level unit 12, as it is configured to continuously cycle on and check for a signal from control unit 14. Once communication is established between the two units 12 and 14, the operator pushes the mode button 80 to display the roll data on display panel 90, such as shown in FIG. 6, showing the amount of degrees off level and the amount of distance to raise one side of recreational vehicle 16 to level recreational vehicle 16 in the side-to-side direction. The operator uses this information to engage the leveling mechanism(s) 18 to raise one side of recreational unit 16 the appropriate amount. Displaying the actual distance for side-to-side leveling can be easily accomplished due to the fact that recreational vehicles 16 are generally the same width. If recreational vehicle 16 used with leveling system 10 is not a standard width, then the operator must achieve the side-to-side leveling by adjusting the leveling mechanism 18 until the degree of roll tilt shows zero. Once the side-to-side direction is level, the operator unhooks recreational vehicle 16 from the tow vehicle and pushes the mode button 80 again on control unit 14. The display panel 90 of control unit 14 displays the amount, in degrees, from level in the front-to-back direction to communicate to the operator the amount he or she must raise or lower the front or back of recreational vehicle 16 by utilizing leveling mechanism 18. The operator engages leveling mechanism 18 until the readout on display panel 90 goes to zero, indicating that recreational vehicle 16 is level in the front-to-back direction and, therefore, at its level condition 20. Because control unit 14 is hand-held, this can be accomplished with the operator outside recreational vehicle 14 operating the leveling mechanisms 18. If desired, leveling system 10 can be adapted to include the length information for specific lengths of recreational vehicles 16 and/or to allow the operator to input the length into its operating system, such as at flash memory 60, by entering the data at control unit 14. In the preferred embodiment, battery monitoring circuit 61 of level 12 and control 14 units is configured to transmit battery level information to display panel 90 when the amount of power in batteries 40 or 86 reach a certain low level. Alternatively, leveling system 10 can also be configured to such that the operator can access the battery level information by pushing the mode button 80 on control unit 14 when he or she desires to check the battery levels.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use. For instance, there are numerous components described herein that can be replaced with equivalent functioning components to accomplish the objectives of the present invention. One such modification is the use of different materials than those set forth herein and changes in any dimensional characteristics of the various components.

What is claimed is:

1. A leveling system in combination with a recreational vehicle having a leveling mechanism to place said recreational vehicle in a level condition, said leveling system comprising:
a level unit having a level housing enclosing a controller, a level sensing means, a power supply and a transceiver, said level sensing means configured to determine the pitch and the roll of said recreational vehicle; and
a control unit in spaced apart relation to and communication with said level unit, said control unit having a control housing enclosing a controller, a transceiver and a power supply, said control unit having a display panel for displaying the pitch and roll information of said recreational vehicle and one or more control buttons for activating and/or operating said leveling system;
wherein said level unit and said control unit are separate from said leveling mechanism and the operator of said recreational vehicle utilizes the pitch and roll information to operate said leveling mechanism so as to place said recreational vehicle in said level condition.

2. The leveling system according to claim 1, wherein said level housing comprises a top cover and a bottom cover, said top cover having one or more top side indicating means thereon for indicating the top of said level unit and one or more position indicating means thereon for indicating the direction of the end or side of said recreational vehicle.

3. The leveling system according to claim 1 further comprising a bandwith limiter and a retriggerable power control circuit disposed in each of said level unit and said control unit.

4. The leveling system according to claim 1, wherein said controller and said transceiver in each of said level unit and said control unit are integrated.

5. The leveling system according to claim 1, wherein said level sensing means is a dual-axis accelerometer.

6. The leveling system according to claim 1, wherein said level unit and said control unit are in wireless communication.

7. The leveling system according to claim 6, wherein said level unit is disposed inside said recreational vehicle and said control unit is configured to operate outside of said recreational vehicle.

8. The leveling system according to claim 1, wherein said level unit has one or more means for connecting said level unit to said recreational vehicle.

9. The leveling system according to claim 1, wherein said display panel is a LCD screen.

10. The leveling system according to claim 1, wherein said control unit has a clip member attached to said control housing.

11. A leveling system in combination with a recreational vehicle having a leveling mechanism to place said recreational vehicle in a level condition, said leveling system comprising:
a level unit mounted in said recreational vehicle, said level unit having a level housing enclosing a controller, a level sensing means, a power supply and a transceiver, said level sensing means configured to determine the pitch and the roll of said recreational vehicle and wirelessly transmit the pitch and roll information; and
a control unit in spaced apart relation to and in wireless communication with said level unit, said control unit having a control housing enclosing a controller, transceiver and a power supply, said control unit having a display panel for displaying the pitch and roll information recreational vehicle received from said level unit of said and one or more control buttons for activating and/or operating said leveling system;
wherein said level unit and said control unit are separate from said leveling mechanism and the operator of said recreational vehicle utilizes the pitch and roll information to operate said leveling mechanism so as to place said recreational vehicle in said level condition.

12. The leveling system according to claim 11, wherein said controller and said transceiver in each of said level unit and said control unit are integrated.

13. The leveling system according to claim 11, wherein said level sensing means is a dual-axis accelerometer.

14. The leveling system according to claim 11, wherein said level housing comprises a top cover and a bottom cover, said top cover having one or more top side indicating means thereon for indicating the top of said level unit and one or more position indicating means thereon for indicating the direction of the end or side of said recreational vehicle.

15. The leveling system according to claim 14, wherein said level unit is disposed inside said recreational vehicle and said control unit is configured to operate outside of said recreational vehicle.

16. The leveling system according to claim 1, wherein said control unit has a clip member attached to said control housing.

17. A method of leveling a recreational vehicle using a leveling system comprising a level unit and a spaced apart control unit in combination with a separate leveling mechanism, said vehicle leveling method comprising the steps of:
a) mounting said level unit inside said recreational vehicle;
b) calibrating said level unit with by engaging one or more control buttons on said control unit;
c) parking said recreational vehicle;
d) activating said leveling system by engaging or more of said control buttons on said control unit;
e) communicating between said control unit and said level unit;
f) determining the pitch and roll of said recreational vehicle with a level sensing means disposed in a level housing of said level unit;
g) transmitting the pitch and roll information to said control unit by a first transceiver disposed in said level unit to a second transceiver disposed in said control unit;
h) displaying the pitch and roll information on said control unit; and
i) leveling said recreational vehicle in both the side-to-side direction and the front-to-back direction using said leveling mechanism based on said pitch and roll information displayed on said control unit.

18. The leveling method according to claim 17, wherein said level unit and said control unit are in wireless communication and said communicating step and said transmitting step are performed wirelessly.

19. The leveling method according to claim 17, wherein said level sensing means is a dual-axis accelerometer.

20. The leveling method according to claim 17, wherein said level unit is disposed inside said recreational vehicle and said control unit is configured to operate outside of said recreational vehicle.
